(19) United States
(12) Patent Application Publication
(10) Pub. No.: US 2009/0042029 A1
(43) Pub. Date: Feb. 12, 2009

(54) POLYAMIDE NANOFIBERS AND METHODS THEREOF

(75) Inventors: Mickael Havel, Philadelphia, PA (US); Yury Gogotsi, Warminster, PA (US); Vadym Mochalin, Philadelphia, PA (US); Kris Behler, Ewing, NJ (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DREXEL UNIVERSITY, Philadelphia, PA (US)

(21) Appl. No.: 12/101,319

(22) Filed: Apr. 11, 2008

Related U.S. Application Data
(60) Provisional application No. 60/911,522, filed on Apr. 13, 2007.

(51) Int. Cl. D02G 3/00; C08G 69/26; B29C 47/08; H05B 6/00

(52) U.S. Cl. 428/372; 428/397; 528/332; 428/398; 524/606; 264/465; 264/441; 977/742; 977/774

(57) ABSTRACT

Provided are methods for dissolving polyamides under ambient conditions and for forming polyamide nanofibers by electrospinning. Also provided are methods for incorporating nanoparticles, including nanotubes, into such nanofibers.

### CROSS-REFERENCE TO RELATED APPLICATIONS

This application claims the benefit of U.S. Provisional Application No. 60/911,522 filed Apr. 13, 2007, the entirety of which is incorporated by reference herein.

### FIELD OF THE INVENTION

The present invention relates to the fields of polymers, polymer solutions, and electrospinning nanofibers from polymer solutions. The present invention also pertains to polyamides.

### BACKGROUND OF THE INVENTION

Various scientific and patent publications are referred to herein. Each is incorporated by reference in its entirety.

Polymeric nanofibers have application to a broad range of fields. These fields include, inter alia, tissue engineering, specialty filters, reinforcements, protective clothing, catalyst supports, and various coatings. R. Dersch, et al., J. of Polymer Sci.: Part A: Polymer Chemistry, 2002, 41, 545-553; U.S. Pat. App. 2006/0137318, Pub. Date. Jun. 26, 2006. The incorporation of nanoparticles, such as nanotubes or nanoclays, into polymeric nanofibers holds additional appeal because nanoparticles can alter or even enhance the mechanical, electrical, and chemical properties of the fibers. E.g., H. Zeng, et al., In situ Polymerization Approach To Multiwalled Carbon Nanotubes-Reinforced Nylon 1010 Composites: Mechanical Properties And Crystallization Behavior, Polymer, 2006, 47, 113-122.

Polyamides are especially attractive candidates for many applications because of their unique mechanical and chemical properties. Polyamide-11 and polyamide-12 are of particular interest because these polymers possess a combination of heat resistance, impact strength, chemical resistance, and low moisture pick-up that renders them suitable for particularly demanding applications, including automotive applications, aerospace applications, oil and gas transport, food and beverage packaging, sporting goods. Polyamide-11 and polyamide-12 are particularly suitable for use in applications that require chemical resistance, such as substrates for chemical synthesis, catalyst supports, filters, and the like; polyamide-11 is known to have a low solubility. Detailed information regarding the properties and characteristics of polyamide-11 and polyamide-12 is available at: Rilsan PA11: Created From A Renewable Source, Arkema, Inc. Corporate Materials, http://www.arkema-inc.com/literature/pdf/738.pdf (accessed Dec. 28, 2006).

Because of their high chemical resistance, polyamide-11 and polyamide-12 are typically processed by melt coating and thermal spraying. See U.S. Pat. No. 4,273,798, Jun. 16, 1981, to Scheiber, et al. These processes, however, are not suitable for all applications or for temperature-sensitive substrates. Furthermore, the high temperatures inherent in melt processing techniques render such techniques unsuitable for incorporating temperature-sensitive materials into a bulk polymer for further processing.

The inherent chemical resistance of polyamides, particularly polyamide 11 and polyamide-12, also presents challenges to the formation of polyamide nanofibers. Although nanofibers are known to be formed by an electrospinning process, polyamides have not been formed into nanofibers by means of electrospinning. Historically, polyamide-11 is dissolved in high boiling point solvents such as m-cresol (boiling point of 200° C.) or benzyl alcohol (boiling point of 205° C.). E.g., Robert, et al., Characterization of Polyamides 6, 11, and 12: Determination of Molecular Weight by Size Exclusion Chromatography, Pure Appl. Chem., 2004, 76, 11, 2009-2025; S. Acierno, et al., Effect Of Short Chain Branching Upon The Crystallization Of Model Polyamides-11, Polymer, 2005, 46. 10331-10338. Use of such high boiling point solvents, however, renders electrospinning of polyamide nanofibers difficult under ambient conditions. Because these solvents evaporate slowly under ambient conditions, an undesirable quantity of excess solvent remains after the polymer is electrospun onto a substrate. The excess solvent in turn causes the deposited polymer to flow across the substrate instead of solidifying into a defined fiber.

While polyamide-11 may be dissolved in solvents other than m-cresol and benzyl alcohol, these alternative solvents are not be suitable for all electrospinning applications. Polyamide-11 may also be dissolved in sulfuric acid, e.g., Q. Zhang et al., Morphology of Conductive Blend Fibers of Polyaniline and Polyamide-11, Synthetic Metals, 2001, 123, 481-485, but the use of sulfuric acid may require certain safety precautions that reduce its utility and sulfuric acid may not be suitable as an electrospinning solvent. Certain fluorochemicals, such as 1,1,1,3,3,3,-hexafluoro-2-propanol are capable of dissolving polyamide-12. Stephens, et al., Effect of the Electrospinning Process on Polymer Crystallization Chain Conformation in Nylon-6 and Nylon-12, Macromolecules, 2004, 37, 877-881. Fluorochemicals are, in some cases, comparatively expensive and are therefore not always optimal for use in applications where cost is a consideration.

Accordingly, because of the unique physical characteristics and chemical resistance profiles of polyamide-11, polyamide-12, and other polyamides, there is a need for a method for dissolving polyamides so as to form a solution capable of being used as a coating or capable of forming polyamide nanofibers through electrospinning, all preferably under ambient conditions. There is also a need to incorporate nanoparticles into polyamide nanofibers.

### SUMMARY OF THE INVENTION

In overcoming the challenges associated with forming polyamide nanofibers under ambient conditions and capable of incorporating nanoparticles, the present invention provides, inter alia, methods for forming a polyamide solvent solution, comprising: dissolving one or more polyamides in a mixed solvent, wherein the mixed solvent comprises at least one polar solvent species and at least one non-polar solvent species.

In another aspect, the present invention provides a composition, comprising: one or more polyamides, at least one polar solvent species, and at least one non-polar solvent species.

Further disclosed is a polymeric fiber, comprising: a nanofiber, wherein the nanofiber is characterized as having a cross-sectional dimension of from about 1 nm to about 20,000 nm, wherein the nanofiber is characterized as electrospun from a solution comprising at least one polar solvent species, at least one non-polar solvent species, polyamide-X, polyamide-Y,Z, or any combination thereof, and wherein X is an integer in the range of from 4 to 12, Y is an integer in the range of from 4 to 12, and Z is an integer in the range of from 4 to 12.

Additionally disclosed is a method, comprising dissolving at least one polyamide in a solvent mixture to give rise to a polymer solution, wherein the at least one polyamide comprises polyamide-X, polyamide-Y,Z, or any combination thereof, wherein X is an integer in the range of from 4 to 12, Y is an integer in the range of from 4 to 12, and Z is an integer in the range of from 4 to 12; and electrospinning one or more nanofibers from the polymer solution.

Further provided is a polymeric fiber, comprising a nanofiber, characterized as having a cross-sectional dimension of from about 1 nm to about 750 nm, wherein the nanofiber comprises polyamide-11, polyamide-12, or any combination thereof.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 is a scanning electron microscope (“SEM”) image of electrospun nanofibers of polyamide-11 obtained from a solution of dichloromethane and formic acid, present in a 1:1 volumetric ratio, and 3 weight percent polyamide-11;

FIG. 2 illustrates the diameter distribution of polyamide fibers electrospun from a solution of dichloromethane and formic acid, present in a 1:1 volumetric ratio with 3 weight percent polyamide-11;

FIG. 3A is an SEM image of electrospun polyamide-11 nanofibers characterized as being ribbons in form, FIG. 3B depicts the electrospun polyamide-11 nanofibers at a higher magnification, FIG. 3C depicts electrospun polyamide-12 nanofibers, and FIG. 3D depicts the electrospun polyamide-12 nanofibers at a higher magnification;

FIG. 4 depicts Raman spectra of polyamide-11 and polyamide-12 electrospun nanofibers and pellets;

FIG. 5A is an SEM image of polyamide-12 nanofibers, electrospun at 12 kV with a distance of 7 inches between the electrodes, from a 1:1 solution of formic acid and dichloromethane and 2.5 weight percent polyamide-12;

FIG. 5B illustrates the distribution of nanofiber diameters for the polyamide-12 nanofibers shown in FIG. 5A;

FIG. 6A is an SEM image of high molecular weight polyamide-11 nanofibers electrospun at 10 kV with a distance of 10 cm between the electrospinner electrodes from a 1:1 solution of formic acid and dichloromethane and 2.5 weight percent polyamide-11—the fibers show a circular cross-sectional area;

FIG. 6B illustrates the distribution of diameters of the nanofibers illustrated in FIG. 6A;

FIG. 7 is an SEM image of nanofibers of high molecular weight polyamide-11; the nanofibers were electrospun at 10 kV with a distance between the electrospinner electrodes of about 10 cm, from a 1:1 solution of formic acid and dichloromethane and 5 weight percent polyamide-11. Ribbon-form nanofibers are shown;

FIG. 8 is a SEM image of the nanofibers of FIG. 7 at additional magnification. Ribbon-shaped nanofibers are shown;

FIG. 9 is a SEM image of ribbon nanofibers having a zig-zag structure—the nanofibers were formed by electrospinning a 1:1 solution of formic acid and dichloromethane and 5 weight percent polyamide-11; and

FIG. 10 is a SEM image of the ribbon nanofibers of FIG. 9, at additional magnification, formed by electrospinning a 1:1 solution of formic acid and dichloromethane and weight percent polyamide-11.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

In a first aspect, the present invention provides methods for forming a polyamide solvent solution, such methods including dissolving one or more polyamides in a mixed solvent, wherein the mixed solvent comprises at least one polar solvent species and at least one non-polar solvent species, with at least one of the one or more polar or of the one or more non-polar solvent species preferably having comparatively low boiling points, contemplated as being less than about 200° C.

Suitable polyamides include polyamide-X, polyamide-Y,Z, or any combination thereof, wherein X is an integer in the range of from 4 to 12, Y is an integer in the range of from 4 to 12, and Z is an integer in the range of from 4 to 12. Polyamide-11 and polyamide-12 are considered particularly suitable, but the invention is not limited to those two polyamides. Suitable polyamides are commercially available from Arkema, Inc, www.arkema.com, BASF Corp, www.basf.com, DuPont Corp., wow.dupont.com, and Degussa, www.degussas.com.

It is contemplated that the concentration of the one or more polyamides is in the range of from about 0.1 weight percent to about 20 weight percent based on total weight of the polyamide solvent solution. The concentration of the one or more polyamides is, in some embodiments, in the range of from about 1 weight percent to about 10 weight percent based on total weight of the polyamide solvent solution, or in the range of from about 2 weight percent to about 9 weight percent based on total weight of the polyamide solvent solution, or in the range of from about 3 weight percent to about 5 weight percent based on total weight of the polyamide solvent solution.

The volumetric ratio of the polar solvent species to the non-polar solvent species is in the range of from about 0.8:1 to about 1:0.8. Formic acid (boiling point of about 101° C.) is an especially suitable polar solvent species, and dichloromethane (boiling point of about 66° C.) is an especially suitable non-polar solvent species; both are commercially available from Sigma-Aldrich, www.sigmaaldrich.com.

It is contemplated that the disclosed methods further include dissolving the one or more polyamides in the mixed solvent with one or more nanoparticles. Suitable nanoparticles include single-wall carbon nanotubes, multi-wall carbon nanotubes, nanodiamonds, metallic nanoparticles, nanoclay particles, quantum dot nanocrystals, polymeric nanoparticles, or any combination thereof. Suitable nanoparticles include, in some configurations, one or more carboxyl groups, one or more carboxylic acid groups, or any combination thereof. Nanoparticle concentrations are in the range of from about 0.01 weight percent to about 80 weight percent based on total weight of the one or more polyamides dissolved in the solvent solution. Without being bound to any particular mode of operation, it is believed that the carboxyl groups present on certain suitable nanoparticles can form hydrogen bonds with hydrogen atoms present in the polyamide so as to connect the nanoparticles to the polyamide.

It is also believed, without being bound to any particular theory, that a carboxyl group of a nanoparticle can, in certain configurations, undergo a condensation reaction with a hydrogen present on the polyamide so as to covalently bond the nanoparticle to the polyamide.

It is envisioned that the dissolving occur at ambient conditions. The invention also includes compositions made according to the described methods.

Also provided are compositions, which compositions include one or more polyamides, at least one polar solvent species, and at least one non-polar solvent species. Suitable polyamides, polar solvent species, and non-polar solvent species are described elsewhere herein. It is envisioned that at least one of the at least one polar solvent species or the at least one non-polar solvent species has a boiling point of less than about 200° C.

The polyamides are present in a concentration is in the range of from about 0.1 weight percent to about 20 weight percent based on total weight of the composition, in the range of from about 1 weight percent to about 10 weight percent based on total weight of the composition, in the range of from about 2 weight percent to about 9 weight percent based on total weight of the composition, or even in the range of from about 3 weight percent to about 5 weight percent based on the total weight of the composition. Polyamide concentrations in the range of from about 2 to about 5 weight percent of the total weight of the composition are considered particularly suitable.

Suitably, the volumetric ratio of the polar solvent species to the non-polar solvent species is in the range of from about 0.8:1 to about 1:0.8.

The claimed compositions also, in some embodiments, include one or more nanoparticles; suitable nanoparticles are described elsewhere herein, and are envisioned as present in the range of from about 0.01 weight percent to about 80 weight percent based on total weight of the one or more polyamides of the composition.

Also disclosed are polymeric fibers, which fibers include a nanofiber, wherein the nanofiber is characterized as having a cross-sectional dimension of from about 1 nm to about 20,000 nm, wherein the nanofiber is characterized as electrospun from a solution comprising a polar solvent species, a non-polar solvent species, polyamide-X, polyamide-Y,Z, or any combination thereof, and wherein X is an integer in the range of from 4 to 12, Y is an integer in the range of from 4 to 12, and Z is an integer in the range of from 4 to 12.

It is envisioned that the cross-sectional dimension of the nanofiber is in the range of from about 2 nm to about 2000 nm, or in the range of from about 5 to about 1500 nm, or in the range of from about 100 nm to about 500 nm, or in the range of from about 5 nm to about 100 nm.

Suitable nanofibers may have non-circular cross-sectional areas, circular cross-sectional areas, or cross-sectional areas that are polygonal in form, having from 2 to 12 sides.

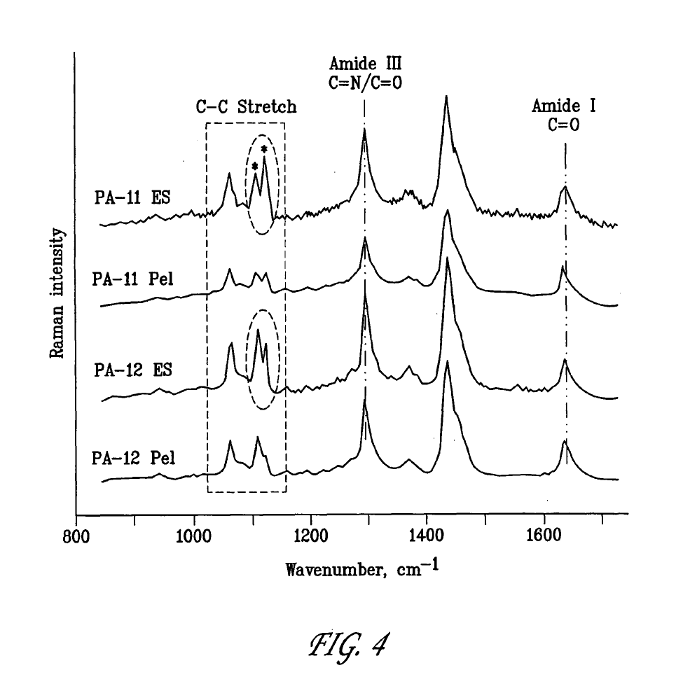

In some cases, the nanofibers may be in the form of ribbons. While not being bound to any particular mode of operation, it is believed that such ribbon-form nanofibers are formed as solvent enclosed within a thin polymer film formed on a liquid jet emanating from an electrospinning device evaporates, thus causing the circular cross-section of the liquid jet to collapse into elliptical and then flat cross-sections. See Koombhongse et al., Flat Polymer Ribbons and Other Shapes by Electrospinning, J. of Polymer Sci. Part B, 2001, 39, 2598-2606. In some configurations, see FIG. 4, and without being bound to any particular theory of operation, it is believed that the shift in the peak at 1130 cm⁻¹ of the Raman spectra of electrospun polyamide-11 and polyamide-12, evidences a helix-type conformation in the hydrocarbon region of the electrospun polyamide-12. See Stephens et al.

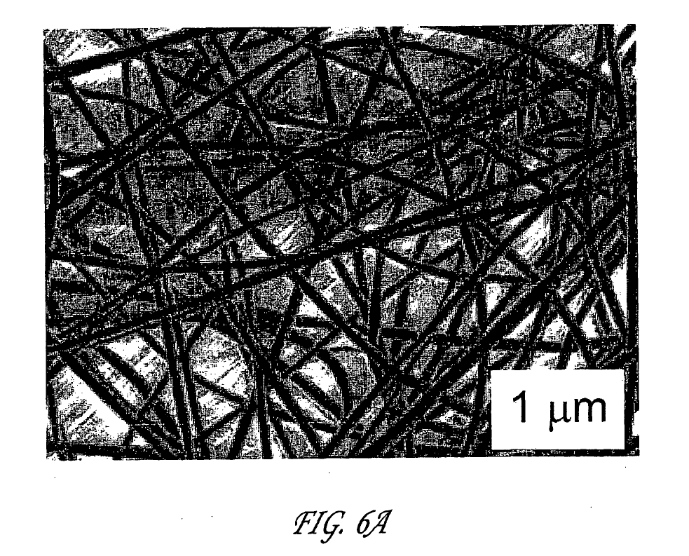

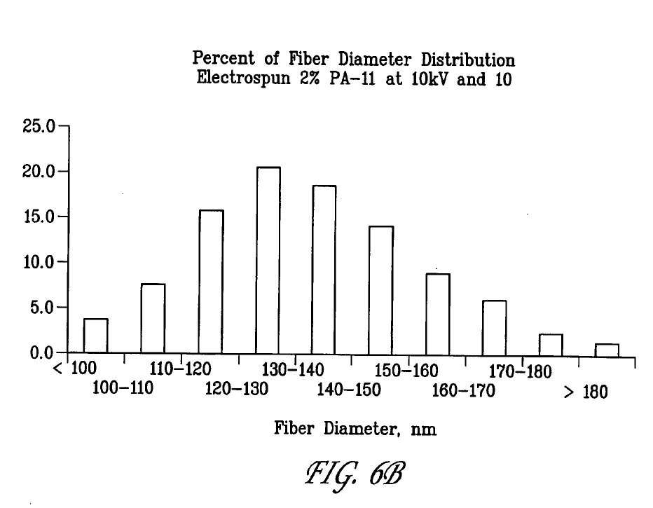

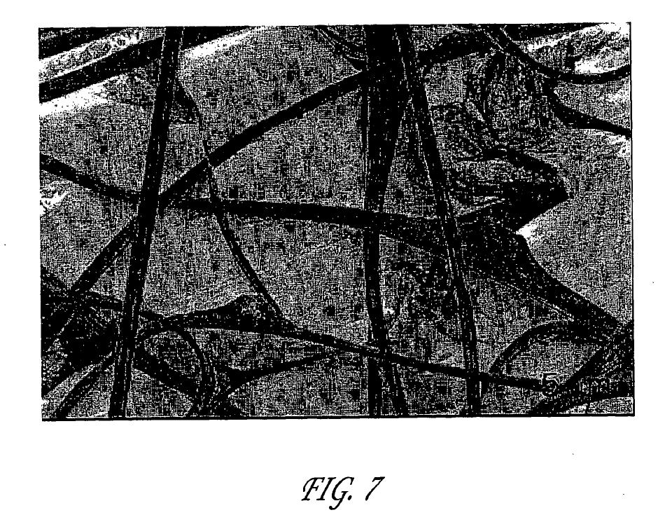

Also, without being bound to any particular form of operation, it is believed that electospinning polymers from solutions having comparatively higher concentrations of polyamide, e.g., 5 weight percent polyamide-12 in a 1:1 formic acid:dichloromethane solution, is comparatively more likely to give rise to ribbon-type nanofibers, as is seen by comparing FIG. 6a (2.5 weight percent polyamide-11; circular fibers) with FIG. 7 (5% polyamide-11; ribbon-type fibers).

It is contemplated that in some cases, the ribbon-type nanofibers are capable of forming T-shaped structures so as to give rise to a net-like collection of nanofibers, as shown in FIG. 7.

Suitable nanofibers can be hollow-core or solid-core; hollow-core fibers have core diameters in the range of from about 1 nm to about 5000 nm.

Suitable polymeric fibers can also include one or more nanoparticles. Suitable nanoparticles are described elsewhere herein.

Also disclosed are methods for manufacturing nanofibers. Such methods include dissolving a polyamide in a solvent mixture to give rise to a polymer solution, and electrospinning one or more nanofibers from the polymer solution.

Suitable polyamides are described elsewhere herein; it is envisioned that the polyamides are present at a concentration in the range of from about 1 weight percent to about 15 weight percent based on total weight of the polymer solution.

Electrospinning is well-known in the art, and typically includes dispensing the polymer solution from a electrically charged device onto a substrate. Suitable charged devices include containers capable of dispensing the polymer solution in the direction of the substrate; such containers can include sprayers, syringes, pumps, extruders, tanks, pistons, spinnerets, and the like. Electrospinning techniques suitable for use in the present invention are described in U.S. Pat. No. 7,112,293, to Dubson, et al., issued Sep. 26, 2006; U.S. Pat. No. 4,323,535, to Bornat, et al., issued Apr. 6, 1982; and U.S. Pat. No. 6,713,011, to Chu, et al., issued Mar. 30, 2004, the entirety of which is incorporated by reference. It is envisioned that the electrospinning occurs under ambient conditions.

It is envisioned that, in some embodiments, the method includes adjusting the concentration of the one or more polyamides so as to render the polymer solution capable of being electrospun into one or more nanofibers having a particular form. As discussed in Example 5 and Example 6, and without being bound to any particular theory of operation, increasing the concentration of the polyamide present in the polymer solution, under certain conditions, gives rise to ribbon-form fibers.

It is envisioned that the nanofibers are electrospun onto a substrate. Substrates are suitably polymers, metals, coated metals, fabrics, ceramics, or any combination thereof.

It is envisioned that the dissolving occurs at ambient conditions, and the solvent mixture is suitably chosen to allow for the dissolving to occur at ambient conditions.

The methods further include contacting the polymer solution with one or more nanoparticles; suitable nanoparticles are described elsewhere herein, and are present in the range of from about 0.01 weight percent to about 80 weight percent of the polymer dissolved in the solvent solution.

Suitable solvent mixtures include at least one polar solvent species—suitably formic acid—and at least one non-polar solvent species—suitably dichloromethane. Preferable volumetric ratios of the polar and non-polar solvent species are described elsewhere herein, as are preferable boiling points for the polar and non-polar solvent species.

The invention also includes fibers made according to the claimed method.

Further described are polymeric fibers, characterized as having a cross-sectional dimension of less than about 750 nm, wherein the nanofiber comprises polyamide-11, polyamide-12, or any combination thereof.

Cross-sectional dimensions of the polymeric fibers can be in the range of from about 2 nm to about 500 nm, or in the range of from about 100 nm to about 300 nm, or in the range of from about 150 nm to about 200 nm.

The polymeric fibers have a circular cross-sectional area, a non-circular cross-sectional area, or, in some embodiments, are in the form of a ribbon. It is envisioned that the polymeric fibers are hollow-core fibers or solid-core fibers. Hollow-core fibers suitably have a core diameter in the range of from about 1 nm to about 750 nm.

In some embodiments, the polymeric fibers include one or more nanoparticles. Suitable nanoparticles are described elsewhere herein.

### EXAMPLES

The following are non-limiting examples that are representative only and do not necessarily restrict the scope of the present invention.

### Example 1

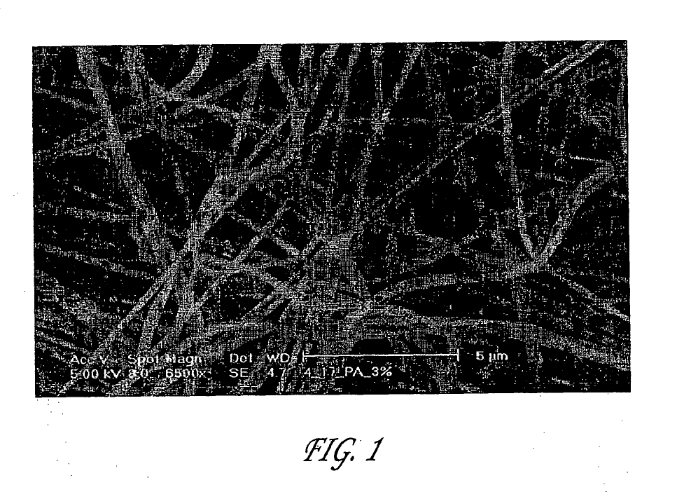

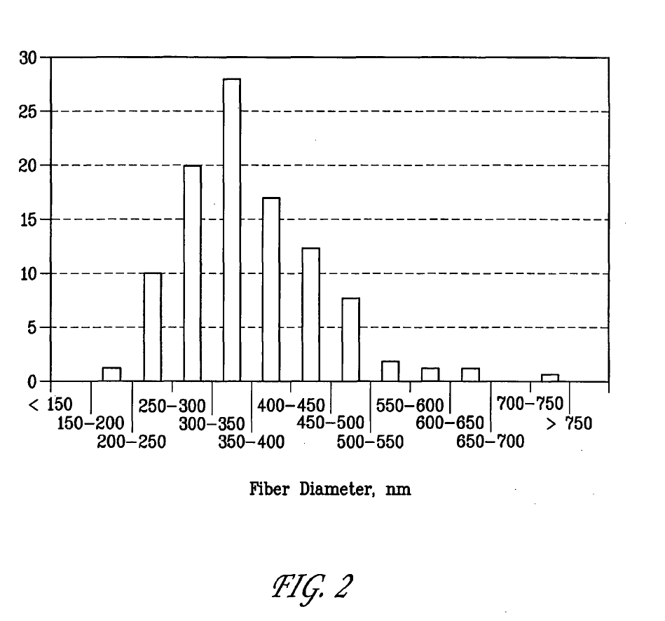

A 1:1 (volumetric) solution of formic acid and dichloromethane and 3 weight percent polyamide-11 was prepared, and the resulting polymer solution was electrospun to form polyamide-11 nanofibers. An electronmicrograph of the nanofibers is depicted in FIG. 1. As can be seen from FIG. 1, the electrospun nanofibers were homogeneous and lacked bead-type formations along their length. The diameter distribution for the nanofibers is shown in FIG. 2. As shown in FIG. 1, the diameter distribution of the nanofibers was narrow, with a mean diameter in the range of about 300 nm.

### Example 2

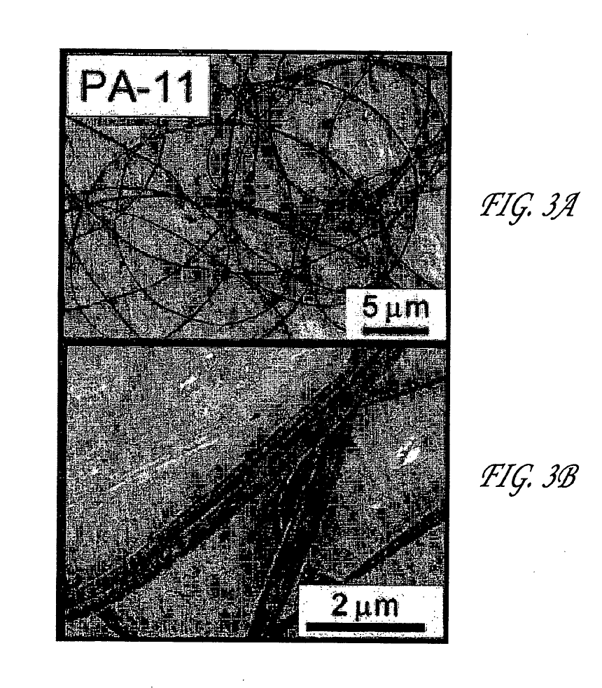

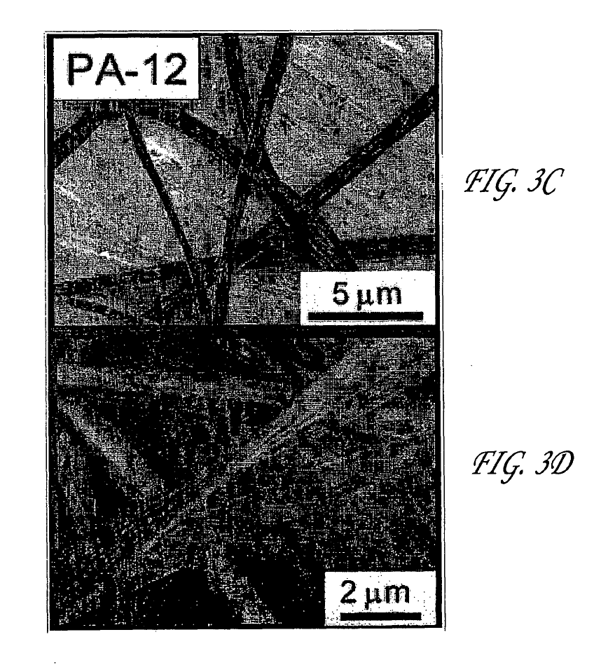

A 1:1 (volumetric) solution of formic acid and dichloromethane and 3 weight percent polyamide-11 was prepared, and the resulting polymer solution was electrospun, as shown in FIG. 3A and FIG. 3B.

### Example 3

A 1:1 (volumetric) solution of formic acid and dichloromethane and 5 weight percent polyamide-12 was prepared, and the resulting polymer solution was electrospun, as shown in FIG. 3C and FIG. 3D, to produce ribbon-type nanofibers.

### Example 4

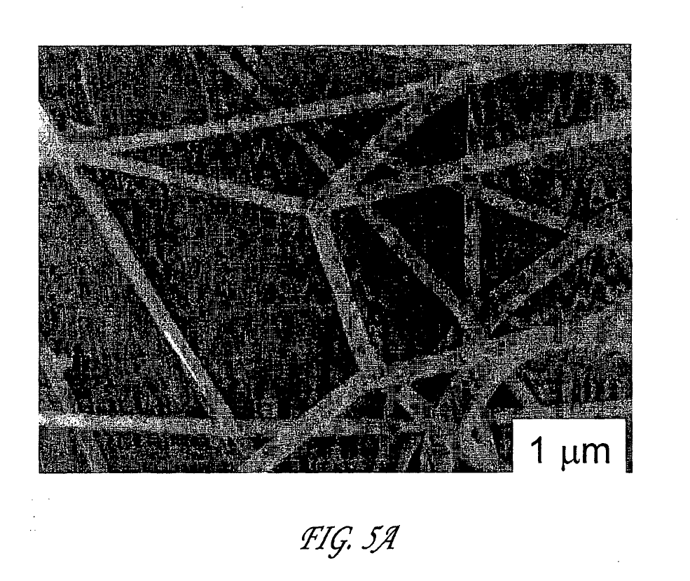

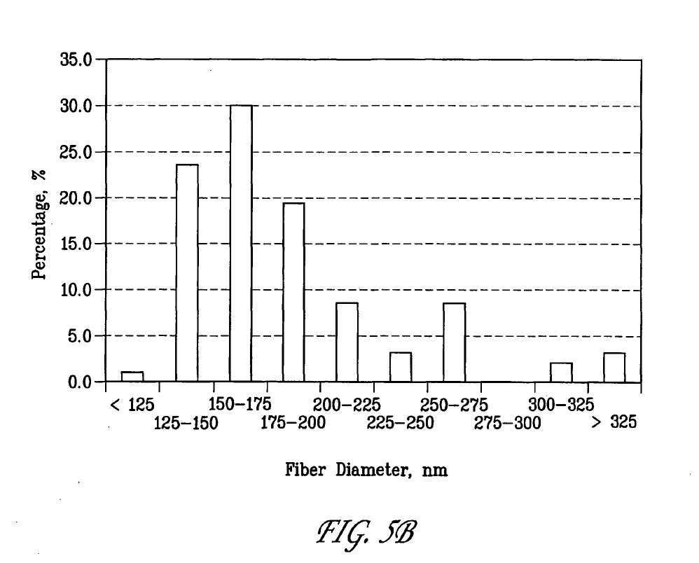

A 1:1 (volumetric) solution of formic acid and dichloromethane and 2.5 weight percent polyamide-12 was prepared, and the resulting polymer solution was electrospun at 12 kV, with 7 inches between the electrodes of the electrospinner. As seen in FIG. 5a, the nanofibers were substantially circular, with a mean diameter in the range of about 200 nm, FIG. 5b.

### Example 5

A 1:1 (volumetric) solution of formic acid and dichloromethane and 2 weight percent high molecular weight, commercially produced polyamide-11 was prepared, and was electrospun at 10 kV with a distance of 10 cm between the electrodes of the electrospinner device. The produced fibers showed a circular morphology, FIG. 6A, with a uniform distribution of fiber diameters. See FIG. 6B.

### Example 6

A 1:1 (volumetric) solution of formic acid and dichloromethane and 5 weight percent high molecular weight, commercially produced polyamide-11 was prepared, and was electrospun at 10 kV with a distance of 10 cm between the electrodes of the electrospinner device. FIG. 7. This 5 weight percent concentration of polyamide-11 resulted in electrospun nanofibers that were ribbon-shaped; one proposed mechanism for the formation of the ribbon-shaped fibers is proposed in Koombhongse et al.

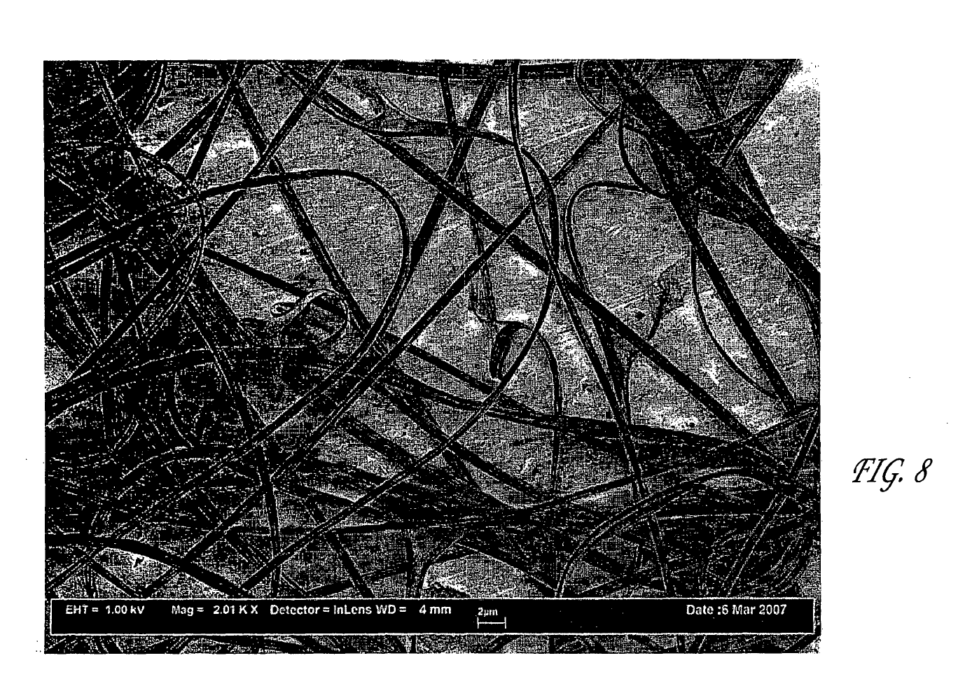

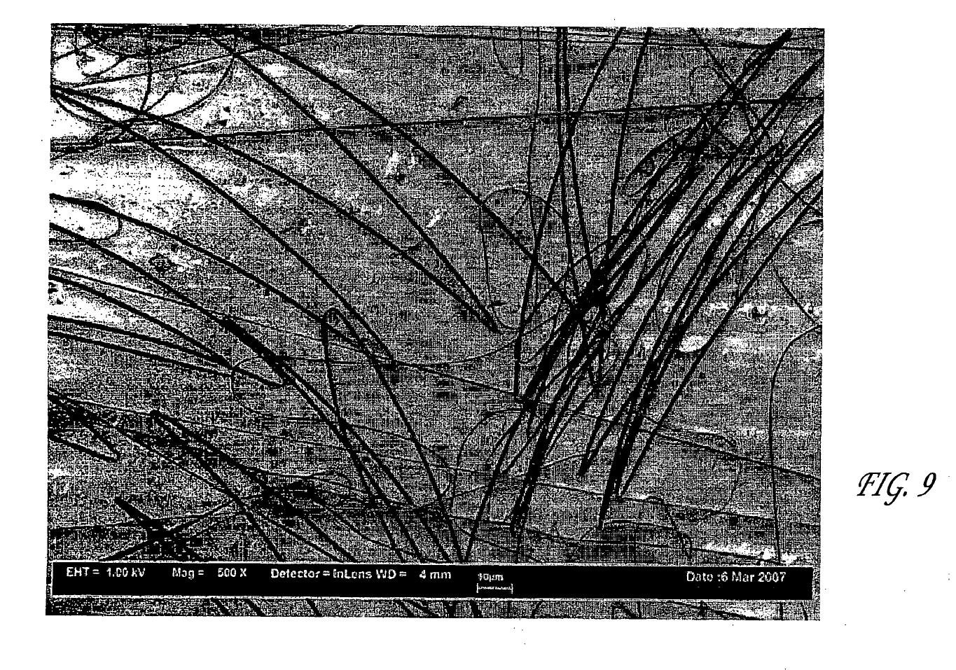

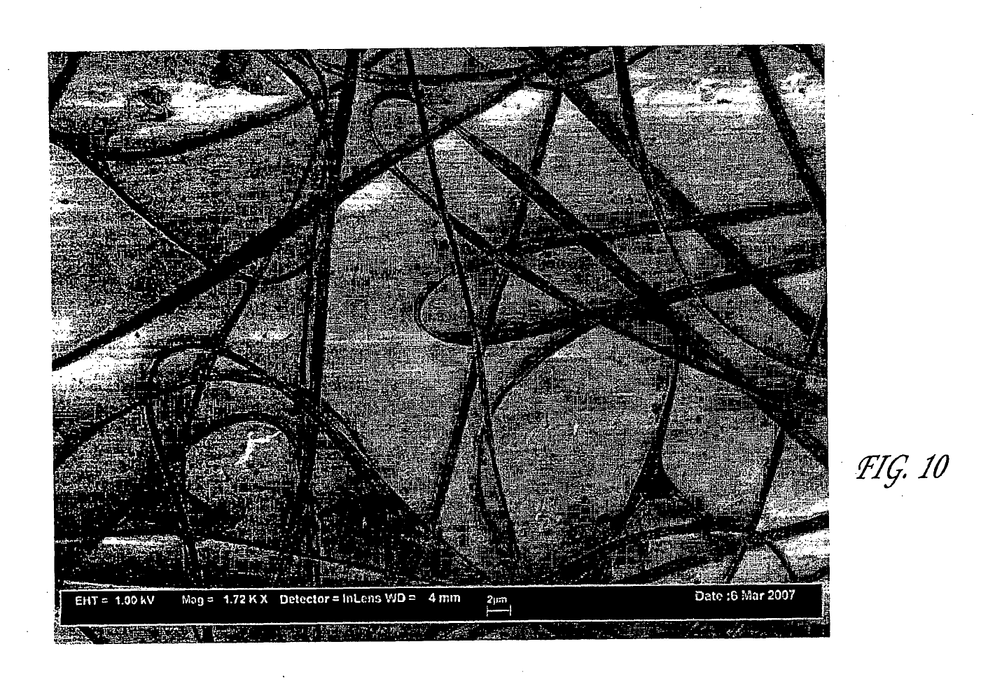

The ribbon-shaped fibers (of FIG. 7) presented an increased diameter as compared to the nanofibers of Example 5. T-shaped structures, also known as ramifications, were formed and led to the formation of net-like structures comprised of 20 nm fibers. SEM images of these fibers are shown in FIG. 8. The ribbon structures were observed to form zig-zag structures, as well, as shown in FIG. 9. FIG. 10 illustrates the polyamide-11 fibers of Example 6 at additional magnification.

What is claimed:

1. A polymeric fiber, comprising:
a nanofiber, characterized as having a cross-sectional dimension of less than about 750 nm, wherein the nanofiber comprises polyamide-11, polyamide-12, or any combination thereof.

2. The polymeric fiber of claim 1, wherein the cross-sectional dimension of the nanofiber is in the range of from about 2 nm to about 500 nm.

3. The polymeric fiber of claim 1, wherein the cross-sectional dimension of the nanofiber is in the range of from about 100 nm to about 300 nm.

4. The polymeric fiber of claim 1, wherein the nanofiber is characterized as having a cross-sectional area having a diameter in the range of from about 150 nm to about 200 nm.

5. The polymeric fiber of claim 1, wherein the nanofiber has a circular cross-sectional area.

6. The polymeric fiber of claim 1, wherein the nanofiber has a non-circular cross-sectional area.

7. The polymeric fiber of claim 1, wherein the nanofiber is characterized as being a ribbon.

8. The polymeric fiber of claim 1, wherein the nanofiber has a cross-sectional area characterized as being a polygon having from 2 to 12 sides.

9. The polymeric fiber of claim 1, wherein the nanofiber is a hollow-core fiber or a solid-core fiber.

10. The polymeric fiber of claim 9, wherein the hollow-core fiber has a core diameter in the range of from about 1 nm to about 750 nm.

11. The polymeric fiber of claim 1, further comprising one or more nanoparticles.

12. The polymeric fiber of claim 11, wherein the one or more nanoparticles comprise a single-wall carbon nanotube, a multi-wall carbon nanotube, a nanodiamond, a metallic nanoparticle, a quantum dot nanocrystal, a nanoclay particle, a polymeric nanoparticle, or any combination thereof.

13. A polymeric fiber, comprising:
a nanofiber, being characterized as having a cross-sectional dimension of from about 1 nm to about 20,000 nm,
wherein the nanofiber is characterized as being electrospun from a solution comprising a polar solvent species, a non-polar solvent species, polyamide-X, polyamide-Y,Z, or any combination thereof, and
wherein X is an integer in the range of from 4 to 12, Y is an integer in the range of from 4 to 12, and Z is an integer in the range of from 4 to 12.

14. The polymeric fiber of claim 13, wherein X equals 11 or 12.

15. The polymeric fiber of claim 13, wherein the cross-sectional dimension of the nanofiber is in the range of from about 2 nm to about 2000 nm.

16. The polymeric fiber of claim 13, wherein the cross-sectional dimension of the nanofiber is in the range of from about 5 to about 1500 nm.

17. The polymeric fiber of claim 13, wherein the cross-sectional dimension of the nanofiber is in the range of from about 100 nm to about 500 nm.

18. The polymeric fiber of claim 13, wherein the nanofiber is characterized as having a cross-sectional area having a diameter in the range of from about 5 nm to about 100 nm.

19. The polymeric fiber of claim 13, wherein the nanofiber is characterized as having a non-circular cross-sectional area.

20. The polymeric fiber of claim 13, wherein the nanofiber is characterized as being a ribbon.

21. The polymeric fiber of claim 13, wherein the nanofiber is characterized as having a circular cross-sectional area.

22. The polymeric fiber of claim 13, wherein the cross-sectional area of the nanofiber is characterized as being a polygon having from 2 to 12 sides.

23. The polymeric fiber of claim 13, wherein the nanofiber is a hollow-core fiber or a solid-core fiber.

24. The polymeric fiber of claim 23, wherein the hollow-core fiber has a core diameter in the range of from about 1 nm to about 5000 nm.

25. The polymeric fiber of claim 13, further comprising one or more nanoparticles.

26. The polymeric fiber of claim 25, wherein the one or more nanoparticles comprise a single-wall carbon nanotube, a multi-wall carbon nanotube, a nanodiamond, a metallic nanoparticle, a quantum dot nanocrystal, a nanoclay particle, a polymeric nanoparticle, or any combination thereof.

27. The polymeric fiber of claim 13, wherein the polar solvent species is formic acid.

28. The polymeric fiber of claim 13, wherein the non-polar solvent species is dichloromethane.

29. The polymeric fiber of claim 13, wherein at least one of the at least one polar solvent species or the at least one non-polar solvent species has a boiling point of less than about 200° C.

30. A method, comprising:
dissolving one or more polyamides in a mixed solvent, wherein the mixed solvent comprises at least one polar solvent species and at least one non-polar solvent species.

31. The composition of claim 30, wherein the one or more polyamides comprise polyamide-X, polyamide-Y,Z, or any combination thereof, wherein X is an integer in the range of from 4 to 12, Y is an integer in the range of from 4 to 12, and Z is an integer in the range of from 4 to 12.

32. The composition of claim 30, wherein X equals 11 or 12.

33. The method of claim 30, wherein the concentration of the one or more polyamides is in the range of from about 0.1 weight percent to about 20 weight percent based on total weight of the polyamide solvent solution.

34. The method of claim 30, wherein the concentration of the one or more polyamides is in the range of from about 1 weight percent to about 10 weight percent based on total weight of the polyamide solvent solution.

35. The method of claim 30, wherein the concentration of the one or more polyamides is in the range of from about 2 weight percent to about 9 weight percent based on total weight of the polyamide solvent solution.

36. The method of claim 30, wherein the concentration of the one or more polyamides is in the range of from about 3 weight percent to about 5 weight percent based on total weight of the polyamide solvent solution.

37. The method of claim 30, wherein the volumetric ratio of the polar solvent species to the non-polar solvent species is in the range of from about 0.8:1 to about 1:0.8.

38. The method of claim 30, wherein the polar solvent species is formic acid.

39. The method of claim 30, wherein the non-polar solvent species is dichloromethane.

40. The method of claim 30 further comprising dissolving the one or more polyamides in the mixed solvent with one or more nanoparticles.

41. The method of claim 40, wherein the one or more nanoparticles comprise a single-wall carbon nanotube, a multi-wall carbon nanotube, a nanodiamond, a metallic nanoparticle, a nanoclay particle, a quantum dot nanocrystal, a polymeric nanoparticle, or any combination thereof.

42. The method of claim 41, wherein a nanoparticle further comprises one or more carboxyl groups, one or more carboxylic acid groups, or any combination thereof.

43. The method of claim 40, wherein the nanoparticle concentration is in the range of from about 0.01 weight percent to about 80 weight percent based on total weight of the one or more polyamides dissolved in the solvent solution.

44. The method of claim 30, wherein the polar solvent species is formic acid.

45. The method of claim 30, wherein the non-polar solvent species is dichloromethane.

46. The method of claim 30, wherein at least one of the at least one polar solvent species or the at least one non-polar solvent species has a boiling point of less than about 200° C.

47. The method of claim 30, wherein the dissolving occurs at ambient conditions.

48. A composition made according to the method of claim 30.

49. A method, comprising:
dissolving at least one polyamide in a solvent mixture to give rise to a polymer solution, wherein the at least one polyamide comprises polyamide-X, polyamide-Y,Z, or any combination thereof, wherein X is an integer in the range of from 4 to 12, Y is an integer in the range of from 4 to 12, and Z is an integer in the range of from 4 to 12; and,
electrospinning one or more nanofibers from the polymer solution.

50. The method of claim 49, wherein X equals 11 or 12.

51. The method of claim 49, wherein the dissolving occurs at ambient conditions.

52. The method of claim 49, further comprising contacting the polymer solution with one or more nanoparticles.

53. The method of claim 52, wherein the one or more nanoparticles comprise a single-wall carbon nanotube, a multi-wall carbon nanotubes, a nanodiamond, a metallic nanoparticle, a quantum dot nanocrystal, a nanoclay particle, a polymeric nanoparticle, or any combination thereof.

54. The method of claim 53, wherein the one or more nanoparticles comprise at least one carboxyl group.

55. The method of claim 52, wherein the nanoparticles are present in the range of from about 0.01 weight percent to about 80 weight percent of the polymer dissolved in the solvent solution.

56. The method of claim 49, wherein the solvent mixture comprises at least one polar solvent species and at least one non-polar solvent species.

57. The method of claim 56, wherein the polar solvent species comprises formic acid.

58. The method of claim 56, wherein the non-polar solvent species comprises dichloromethane.

59. The method of claim 56, wherein at least one of the at least one polar solvent species or the at least one non-polar solvent species has a boiling point of less than about 200° C.

60. The method of claim 56, wherein the volumetric ratio of the polar solvent species to the non-polar solvent species is in the range of from about 0.8:1 to about 1:0.8.

61. The method of claim 49, wherein the concentration of polyamide is in the range of from about 1 weight percent to about 15 weight percent based on total weight of the polymer solution.

62. The method of claim 49, wherein electrospinning comprises dispensing the polymer solution from a electrically charged device onto a substrate.

63. The method of claim 62, wherein the charged device comprises a container capable of dispensing the polymer solution in the direction of the substrate.

64. The method of claim 63, wherein the device comprises a sprayer, a syringe, a pump, an extruder, a tank, a piston, a spinneret, or any combination thereof.

65. The method of claim 62, wherein the substrate comprises a polymer, a metal, a coated metal, a fabric, a ceramic, or any combination thereof.

66. The method of claim 49, wherein the electrospinning is performed under ambient conditions.

67. The method of claim 49, further comprising the step of adjusting the concentration of the one or more polyamides so as to render the polymer solution capable of being electrospun into one or more nanofibers having a particular form.

68. The method of claim 67, wherein a particular form comprises a circular cross-sectional area, a ribbon shape, a branched shape, or any combination thereof.

69. A nanofiber made according to the method of claim 49.

70. A composition, comprising:
one or more polyamides, at least one polar solvent species, and at least one non-polar solvent species.

71. The composition of claim 70, wherein the one or more polyamides comprise polyamide-X, polyamide-Y,Z, or any combination thereof, wherein X is an integer in the range of from 4 to 12, Y is an integer in the range of from 4 to 12, and Z is an integer in the range of from 4 to 12.

72. The composition of claim 70, wherein X equals 11 or 12.

73. The composition of claim 70, wherein the concentration of the one or more polyamides is in the range of from about 0.1 weight percent to about 20 weight percent based on total weight of the composition.

74. The composition of claim 70, wherein the concentration of the one or more polyamides is in the range of from about 1 weight percent to about 10 weight percent based on total weight of the composition.

75. The composition of claim 70, wherein the concentration of the one or more polyamides is in the range of from about 2 weight percent to about 9 weight percent based on total weight of the composition.

76. The composition of claim 70, wherein the concentration of the one or more polyamides is in the range of from about 3 weight percent to about 5 weight percent based on the total weight of the composition.

77. The composition of claim 70, wherein the at least one polar solvent species comprises formic acid.

78. The composition of claim 70, wherein the at least one polar solvent species comprises dichloromethane.

79. The composition of claim 70, wherein at least one of the at least one polar solvent species or the at least one non-polar solvent species has a boiling point of less than about 200° C.

80. The composition of claim 70, wherein the volumetric ratio of the polar solvent species to the non-polar solvent species is in the range of from about 0.8:1 to about 1:0.8.

81. The composition of claim 70, further comprising one or more nanoparticles.

82. The composition of claim 81, wherein the one or more nanoparticles comprise a single-wall carbon nanotube, a multi-wall carbon nanotube, a nanodiamond, a metallic nanoparticle, a nanoclay particle, a quantum dot nanocrystal, a polymeric nanoparticle, or any combination thereof.

83. The composition of claim 80, wherein a nanoparticle further comprises one or more carboxyl groups.

84. The composition of claim 81, wherein the nanoparticles are present in the range of from about 0.01 weight percent to about 80 weight percent based on total weight of the one or more polyamides of the composition.
